(19) United States
(12) Patent Application Publication
(10) Pub. No.: US 2010/0163546 A1
(43) Pub. Date: Jul. 1, 2010

(54) WIRING STRUCTURE, HEATER DRIVING DEVICE, MEASURING DEVICE, AND CONTROL SYSTEM

(75) Inventors: Ikuo NANNO, Otsu-shi (JP); Masahito Tanaka, Kusatsu-shi (JP); Mamoru Egi, Otsu-shi (JP)

Correspondence Address: FOLEY AND LARDNER LLP;SUITE 500, 3000 K STREET NW, WASHINGTON, DC, 20007, US

(73) Assignee: OMRON CORPORATION

(21) Appl. No.: 12/642,518

(22) Filed: Dec. 18, 2009

(30) Foreign Application Priority Data
Dec. 26, 2008 (JP) 2008-332717

(51) Int. Cl. H05B 1/02; H02G 3/00

(52) U.S. Cl. 219/494; 219/482; 174/70 R

(57) ABSTRACT

The number of wirings and the number of switching elements are decreased in a heater, a sensor, and the like. First to ninth heaters that heat a hot plate are connected into a matrix form between first power lines in a row direction and second power lines in a column direction. The first power lines are connected to one end of a power supply through three switching elements, respectively. The second power lines are connected to the other end of the power supply through three switching elements, respectively. On-off control is performed to the switching elements to select the heater to be driven. Therefore, the number of power lines and the number of switching elements are decreased compared with a conventional technique in which the heaters are separately wired.

### BACKGROUND OF THE INVENTION

This application is based on Japanese Patent Application No. 2008-332717 filed with the Japan Patent Office on Dec. 26, 2008, the entire content of which is hereby incorporated by reference.

### 1. TECHNICAL FIELD

The present invention relates to a wiring structure in which the number of wirings, such as a power line and a signal line for a heater or a sensor, is decreased, and a heater driving device, a measuring device, and a control system in which the wiring structure is used.

### 2. RELATED ART

Conventionally, for example, in Japanese Unexamined Patent Publication No. 2001-274069, in temperature control in which a heated substance is placed on a hot plate to perform heat treatment, a temperature regulator controls current conduction of a heater provided in the hot plate such that a temperature at the hot plate becomes a setting temperature based on a detection temperature from a temperature sensor provided in the hot plate.

When plural heaters and plural temperature sensors are provided in the hot plate to perform the temperature control at plural control points, that is, the temperature control of plural channels, the number of power lines of the heaters and the number of signal lines of the temperature sensors are increased.

FIG. 29 illustrates a schematic configuration of a conventional nine-channel temperature control system in which a temperature at a hot plate is controlled at nine control points, and FIG. 30 illustrates a conventional wiring structure of nine heaters provided in the hot plate of FIG. 29.

The temperature control system of FIG. 29 includes a temperature regulator 31 and an output device 35. The temperature regulator 31 performs PID operation to output an operation amount for each channel based on the setting temperature and a detection temperatures PV from nine temperature sensors (not illustrated) provided in a hot plate 30. Based on the operation amount for each channel from the temperature regulator 31, the output device 35 controls opening and closing of switching elements 33-1 to 33-9 such as a relay that are provided so as to separately correspond to heaters 32-1 to 32-9 provided in the hot plate 30, thereby controlling power feeding from an alternating-current power supply 34.

In the heaters 32-1 to 32-9 provided in the hot plate 30, terminals X1 to X9 are respectively connected to one end of the alternating-current power supply 34 through the switching elements 33-1 to 33-9, and terminals Y1 to Y9 are respectively connected to the other end of the alternating-current power supply 34.

The temperature regulator 31 controls the switching elements 33-1 to 33-9 through the output device 35 to separately drive the heaters 32-1 to 32-9.

In the conventional temperature control system, the heaters 32-1 to 32-9 are separately connected to be driven. Therefore, for example, the nine-channel temperature control system of FIG. 29 has 18 power lines and 9 switching elements. As resolution is enhanced, that is, as the number of channels is increased, the number of switching elements and the number of wirings are increased. In particular, the power line having a large diameter is routed longwise between the hot plate and the output device, and unfortunately space design and wiring work become troublesome.

The problem with the increased number of wirings is generated in not only the heater but also the signal lines of the sensor and the like.

### SUMMARY

The present invention has been devised to solve the problems described above, and an object thereof is to decrease the number of wirings in the heater, the sensor, and the like.

(1) In accordance with one aspect of the present invention, a wiring structure of the present invention is a wiring structure that connects a plurality of heaters to a power supply, wherein the plurality of heaters are connected in a matrix form between a plurality of first power lines and a plurality of second power lines, the plurality of first power lines are connected to the power supply through a plurality of corresponding row first opening and closing units, the plurality of second power lines are connected to the power supply through a plurality of corresponding column second opening and closing units, and each of the heaters to be connected to the power supply is selected by opening and closing the corresponding first opening and closing unit and the corresponding second opening and closing unit.

A resistance heater and a lamp heater are preferably used as the heater.

The power supply may be formed by a direct-current power supply or an alternating-current power supply.

The opening and closing unit may be formed by relay or a semiconductor element such as a transistor, a thyristor and a triac.

The matrix connection is not limited to the complete lattice-like matrix in the row direction and the column direction, but the matrix connection may partially include the heater that is not connected into the matrix form, that is, the heater that is connected to the power supply through the separate power line. Plural groups each of which has plural heater lines connected into the matrix form may be provided.

In the wiring structure of the aspect (1) of the present invention, the heaters connected into the matrix form between the plural first power lines in the row direction (or column direction) and the plural second power lines in the column direction (or row direction) can be selected to perform the power feeding by controlling the opening and closing of the first and second opening and closing units. Compared with the conventional wiring structure in which each heater is driven while connected to the power supply through the switching element, the number of power lines and the number of opening and closing units such as the switching element can be decreased.

(2) In the wiring structure of the aspect (1), preferably each of the heaters is formed of a resistive element.

When thermoelectric transducers such as Peltier elements are used as the heaters connected into the matrix form, as described later, a circuit loop is generated by current run-round, and the thermoelectric transducer that generates a temperature difference from an electromotive force and the thermoelectric transducer that generates the electromotive force from the temperature difference negate each other. As a result, it is difficult to generate heat only in the selected thermoelectric transducer, that is, it is difficult to locally generate the heat. On the other hand, in the wiring structure of this aspect of the present invention, the trouble is not generated because the resistance heaters are used as the heaters connected into the matrix form.

(3) In accordance with another aspect of the present invention, a wiring structure of the present invention is a wiring structure that connects a plurality of sensors to a sensor input circuit, wherein the plurality of sensors are connected in a matrix form between a plurality of first signal lines and a plurality of second signal lines, the plurality of first signal lines are connected to the sensor input circuit through a plurality of corresponding row first opening and closing units, the plurality of second signal lines are connected to the sensor input circuit through a plurality of corresponding column second opening and closing units, and each of the sensors to be connected to the sensor input circuit is selected by opening and closing the corresponding first opening and closing unit and the corresponding second opening and closing unit.

In the wiring structure of the aspect (3) of the present invention, the sensors connected into the matrix form between the plural first signal lines in the row direction (or column direction) and the plural second signal lines in the column direction (or row direction) can be selected to take the sensor output in the sensor input circuit by controlling the opening and closing of the first and second opening and closing units. The number of signal lines can be decreased compared with the conventional wiring structure in which the sensor output is taken in while each sensor is connected to the sensor input circuit.

(4) In the wiring structure of the aspect (3), preferably each of the sensors is formed of a resistive element.

The resistance thermometer sensor and the thermistor are preferably used as the sensor formed by the resistive element.

When thermoelectric transducers such as thermocouples are used as the sensors connected into the matrix form, as described later, the circuit loop is generated by the current run-round, and the thermoelectric transducer that generates the temperature difference from the electromotive force and the thermoelectric transducer that generates the electromotive force from the temperature difference negate each other. As a result, the voltages generated by the thermoelectric transducers except for the selected thermoelectric transducer are measured as a whole, that is, it is difficult to locally measure the voltage. On the other hand, in the wiring structure of this aspect of the present invention, the trouble is not generated because the resistance sensors are used as the sensors connected into the matrix form.

(5) In accordance with still another aspect of the present invention, a heater driving device of the present invention is a heater driving device comprising: the wiring structure according to (1) or (2); and a selection unit that selects the heater to be connected to the power supply by controlling the opening and closing of the first opening and closing units and the second opening and closing units.

The heater driving device of the aspect (5) of the present invention may independently be formed, or the heater driving device may be incorporated in the voltage regulator or the temperature regulator.

In the heater driving device, the selection unit can control the opening and closing of the opening and closing unit to selectively feed the power to the heaters. Compared with the conventional heater driving device in which each heater is driven while connected to the power supply through the switching element, the number of power lines and the number of opening and closing units such as the switching element can be decreased.

(6) In accordance with still another aspect of the present invention, a measurement device of the present invention is a measurement device comprising: the wiring structure according to (3) or (4); and a selection unit that selects the sensor to be connected to the sensor input circuit by controlling the opening and closing of the first opening and closing units and the second opening and closing units.

The measuring device of the aspect (6) of the present invention may independently be formed, or the measuring device may be incorporated in the temperature regulator.

In the measuring device, the selection unit can control the opening and closing of the opening and closing unit to selectively take the sensor output in the sensor input circuit. The number of signal lines can be decreased compared with the conventional measuring device in which the sensor output is taken in while each sensor is connected to the sensor input circuit.

(7) In accordance with still another aspect of the present invention, a control system of the present invention is a control system comprising the heater driving device according to the present invention.

In the control system of the aspect (7) of the present invention, compared with the conventional control system, the number of power lines and the number of opening and closing units such as the switching element can be decreased to facilitate the space design and wiring work for routing the power line.

(8) In accordance with still another aspect of the present invention, a control system of the present invention is a control system comprising the measurement device according to the present invention.

In the control system of the aspect (7) of the present invention, compared with the conventional control system, the number of signal lines can be decreased to facilitate the wiring work.

(9) In accordance with still another aspect of the present invention, a control system of the present invention is a control system that controls a temperature of a control target provided with a plurality of heaters, the plurality of heaters being connected in a matrix form between a plurality of first power lines and a plurality of second power lines, the plurality of first power lines being connected to the power supply through a plurality of corresponding row first opening and closing units, the plurality of second power lines being connected to the power supply through a plurality of corresponding column second opening and closing units, the control system comprising: a temperature control unit that outputs an operation amount based on a setting temperature and a detection temperature from a plurality of temperature sensors for detecting a temperature of the control target; and a first selection unit that selects each of the heaters to be driven by controlling the opening and closing of the corresponding first opening and closing unit and the corresponding second opening and closing unit based on the operation amount from the temperature control unit.

In the control system of the aspect (9) of the present invention, the selection unit can control the opening and closing of the opening and closing unit to selectively feed the power to the heaters that are connected into the matrix form between the plural first power lines in the row direction (or column direction) and the plural second power lines in the column direction (or row direction). Compared with the conventional control system in which each heater is driven while connected to the power supply through the switching element, the number of power lines and the number of opening and closing units such as the switching element can be decreased to facilitate the space design and wiring work for routing the power line.

(10) In the control system of the aspect (9), preferably each of the heaters is formed of a resistive element.

In the control system of this aspect of the present invention, the trouble of hardly generating the local heat is not generated unlike the case in which the thermoelectric transducers such as the Peltier elements are used as the heaters connected into the matrix form.

(11) The control system of the aspect (9) or (10) may further comprise a non-interference unit that converts the operation amount from the temperature control unit and provides the converted amount to the first selection unit so as to cancel heat generated by a current bypassing the heater selected by the selection unit.

When the heaters connected into the matrix form is selectively driven, the heat is generated by the surrounding heaters except for the selected heater due to the current run-round although a small amount of heat is generated. On the other hand, in the control system of this aspect of the present invention, the heat generated by the surrounding heaters is considered to be interference, and the non-interference unit converts the operation amount so as to negate the interference. Therefore, an influence of the undesirable heat generated by the surrounding heaters can be reduced to accurately perform the temperature control.

(12) In the control system of the present invention, a plurality of temperature sensors are further provided in the control target, the plurality of temperature sensors are connected in a matrix form between a plurality of first signal lines and a plurality of second signal lines, the plurality of first signal lines are connected to a sensor input circuit through a plurality of corresponding row third opening and closing units, the plurality of second signal lines are connected to the sensor input circuit through a plurality of corresponding column fourth opening and closing units, the control system further includes: a second selection unit that selects the temperature sensors connected to the sensor input circuit by controlling the opening and closing of the corresponding third opening and closing unit and the corresponding fourth opening and closing unit; and a switching unit that switches and provides an input outputted from each of the temperature sensors through the sensor input circuit to a plurality of temperature control units corresponding to the temperature sensors of the temperature control unit, and the temperature control unit controls the second selection unit based on the input of each of the temperature sensors from the switching unit and corresponding each of setting temperatures.

In the control system of the present invention, the second selection unit can control the opening and closing of the third and fourth opening and closing units to select the temperature sensors that are connected into the matrix form between the plural first power lines in the row direction (or column direction) and the plural second power lines in the column direction (or row direction), and the sensor output can be taken in the sensor input circuit. Compared with the conventional control system in which the sensor output is taken in while each sensor is separately connected to the sensor input circuit, the number of signal lines can be decreased to facilitate the wiring work.

(13) In the control system of the aspect (12), preferably the temperature sensor is formed by a resistive element.

In the control system of this aspect of the present invention, the trouble of hardly measuring the local temperature is not generated unlike the case in which the thermoelectric transducers such as the thermocouples are used as the temperature sensors connected into the matrix form.

According to the present invention, the plural power lines and signal lines are shared by the plural heater and sensor. Therefore, compared with the conventional technique, the number of power lines and the number of switching elements can be decreased to facilitate the space design and wiring work for routing the power line and the like.

### BRIEF DESCRIPTION OF THE DRAWINGS

FIG. 1 illustrates a schematic configuration of a temperature control system according to a first embodiment of the present invention;

FIG. 2 illustrates a wiring structure of nine heaters provided in a hot plate of FIG. 1;

FIGS. 3A and 3B illustrate drive of the heater in each state until the hot plate reaches a setting temperature since heating of the hot plate starts;

FIG. 4 illustrates a driving signal for driving the heater;

FIGS. 5A and 5B illustrate a change in temperature at the hot plate and a change in total operation amount of nine channels;

FIGS. 6A to 6C illustrate the drive of the heater according to the total operation amount;

FIGS. 7A and 7B illustrate an example in which a group of four heaters is driven;

FIG. 8 illustrates a driving signal of FIG. 7;

FIG. 9 illustrates current run-round;

FIG. 10 illustrates an influence of the current run-round;

FIG. 11 illustrates a configuration of a temperature regulator that measures a temperature at the hot plate to output an operation amount;

FIG. 12 illustrates a wiring structure of a resistance thermometer sensor provided in the hot plate of FIG. 11;

FIG. 13 illustrates the time a selection unit takes in an input of a sensor in each channel;

FIG. 14 illustrates the current run-round for a sensor including a resistance thermometer sensor;

FIG. 15 illustrates an influence of the current run-round;

FIGS. 16A and 16B illustrate reduction of resistance value due to the current run-round;

FIG. 17 illustrates the current run-round when a Peltier element is used;

FIGS. 18A and 18B illustrate an influence of the current run-round;

FIGS. 19A to 19C illustrate the reason the current run-round is considered to be equivalent to a series-parallel connection;

FIG. 20 illustrates the current run-round when a thermocouple is used;

FIGS. 21A and 21B illustrate an influence of the current run-round;

FIG. 22 illustrates a schematic configuration of a temperature control system according to another embodiment of the present invention;

FIGS. 23A and 23B illustrate a degree of heat generation due to a leakage current;

FIG. 24 illustrates a schematic configuration of a temperature control system according to still another embodiment of the present invention;

FIG. 25 illustrates another example of the wiring structure of the heaters;

FIG. 26 illustrates a schematic configuration of a temperature control system corresponding to the wiring structure of FIG. 25;

FIG. 27 illustrates still another example of the wiring structure of the heaters;

FIG. 28 illustrates still another example of the wiring structure of the heaters;

FIG. 29 illustrates a schematic configuration of a conventional temperature control system; and

FIG. 30 illustrates a conventional wiring structure of heaters.

### DETAILED DESCRIPTION

Hereinafter, preferred embodiments of the present invention will be described with reference to the drawings.

### First Embodiment

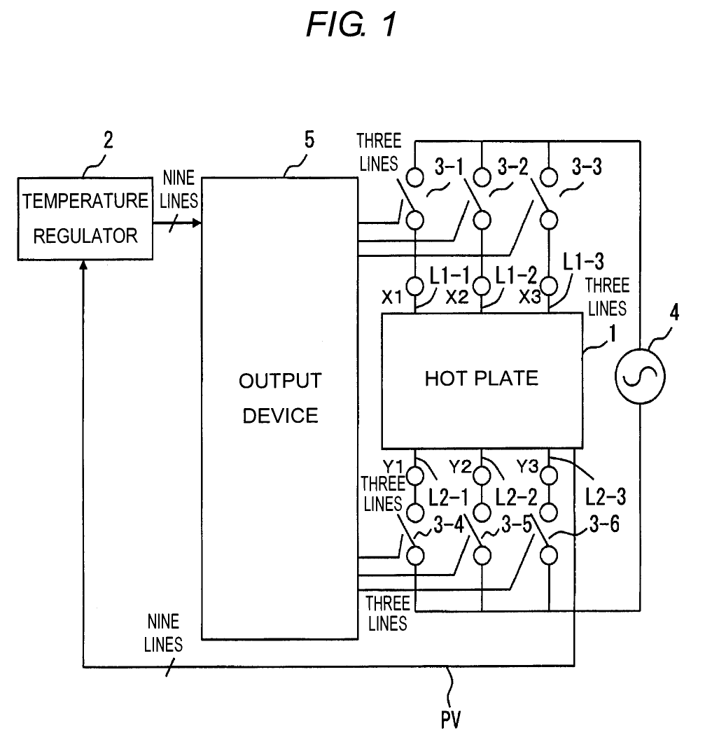

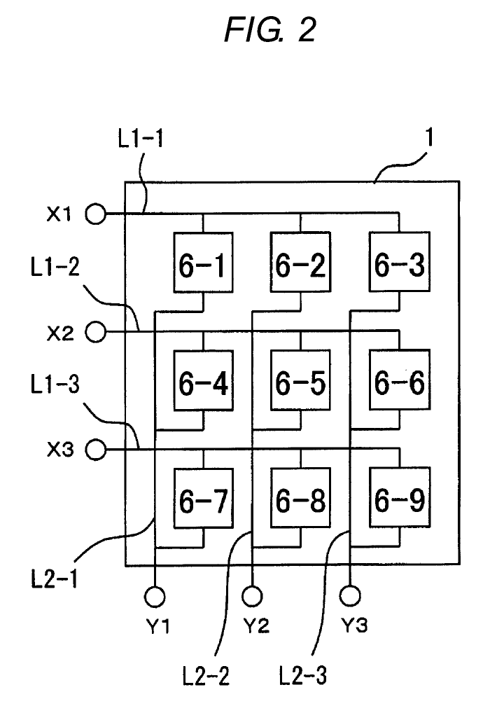

FIG. 1 illustrates a schematic configuration of a temperature control system according to a first embodiment of the present invention, and FIG. 2 illustrates a wiring structure of nine heaters provided in a hot plate 1 of FIG. 1.

The temperature control system of the first embodiment controls nine channels, that is, temperatures at nine control points of the hot plate 1. First to ninth heaters 6-1 to 6-9 and nine temperature sensors (not illustrated) are provided in the hot plate 1.

In the first embodiment, as illustrated in FIG. 2, the first to ninth heaters 6-1 to 6-9 are connected into a matrix form between first power lines L1-1 to L1-3 in a row direction and second power lines L2-1 to L2-3 in a column direction.

That is, one end of each of the first to third heaters 6-1 to 6-3 is connected to the upper first power line L1-1 in the row direction, and the other end is connected to each of the second power lines L2-1 to L2-3 in the column direction. One end of each of the fourth to sixth heaters 6-4 to 6-6 is connected to the intermediate first power line L1-2 in the row direction, and the other end is connected to each of the second power lines L2-1 to L2-3 in the column direction. One end of each of the seventh to ninth heaters 6-7 to 6-9 is connected to the lower first power line L1-3 in the row direction, and the other end is connected to each of the second power lines L2-1 to L2-3 in the column direction.

As illustrated in FIG. 1, connecting terminals X1 to X3 of the row-directional first power lines L1-1 to L1-3 led out from the hot plate 1 are connected to one end of an alternating-current power supply 4 through corresponding switching elements 3-1 to 3-3 that are of plural first opening and closing units. Each of the switching elements 3-1 to 3-3 includes a relay. Connecting terminals Y1 to Y3 of the column-directional second power lines L2-1 to L2-3 led out from the hot plate 1 are connected to the other end of the alternating-current power supply 4 through corresponding switching elements 3-4 to 3-6 that are of plural first opening and closing units.

The temperature control system includes a temperature regulator 2 and an output device 5. The temperature regulator 2 performs PID operation to output an operation amount for nine channels based on a detection temperature (PV) and a setting temperature (goal temperature) from the nine temperature sensors (not illustrated) provided in the hot plate 1. The output device 5 controls the opening and closing of the switching elements 3-1 to 3-3 and 3-4 to 3-6 based on the operation amount from the temperature regulator 2, and the output device 5 controls power feeding from the alternating-current power supply 4 to the heaters 6-1 to 6-9 provided in the hot plate 1.

As described above, the heaters 6-1 to 6-9 are connected into the matrix form between the first power lines L1-1 to L1-3 in the row direction and the second power lines L2-1 to L2-3 in the column direction. When the switching elements 3-1 to 3-3 corresponding to one of the first power lines L1-1 to L1-3 in the row direction and the switching elements 3-4 to 3-6 corresponding to one of the second power lines L2-1 to L2-3 in the column direction are selected and turned on, one of the heaters 6-1 to 6-9 is selected and connected to the alternating-current power supply 4, and therefore one of the heaters 6-1 to 6-9 can be driven.

The output device 5 has a function as a selection unit that selects the heater to be driven. Based on the operation amount for the nine channels from the temperature regulator 2, the output device 5 produces a driving signal to control the opening and closing of the switching elements 3-1 to 3-3 and 3-4 to 3-6, and the output device 5 drives the heaters 6-1 to 6-9 connected into the matrix form.

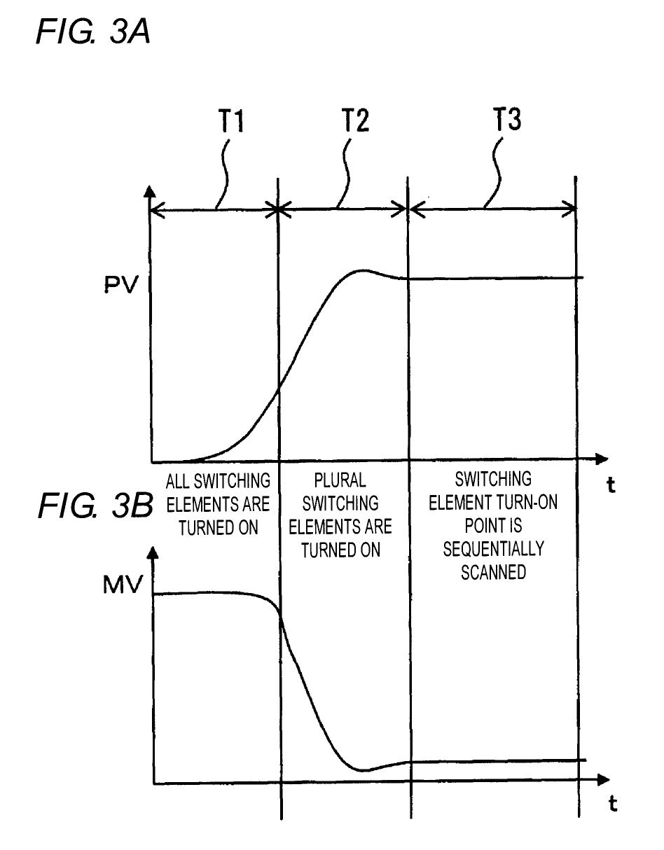

The drive of the heater in the case where the temperature at the hot plate 1 is controlled to an even setting temperature will be described. FIG. 3 illustrates states until the hot plate 1 reaches a setting temperature since heating of the hot plate 1 starts, FIG. 3A typically illustrates a change in detection temperature (PV) of the hot plate 1, and FIG. 3B typically illustrates a change in operation amount (MV) outputted from the temperature regulator 2.

In an initial duration T1 during which the heating starts, the operation amount of FIG. 3B is 100%, and all the switching elements 3-1 to 3-3 and 3-4 to 3-6 are turned on to drive all the heaters 6-1 to 6-9, whereby a detection temperature (PV) at the hot plate 1 rises as illustrated in FIG. 3A.

In a transient duration T2 during which the detection temperature (PV) at the hot plate 1 partially comes close to the setting temperature, the switching elements 3-1 to 3-3 and 3-4 to 3-6 are selectively turned on to selectively drive the heaters.

In a steady-state duration T3 during which the detection temperature (PV) at the hot plate 1 reaches the setting temperature, the switching elements 3-1 to 3-3 and 3-4 to 3-6 are sequentially turned on, that is, the points at which the switching elements 3-1 to 3-3 and 3-4 to 3-6 are turned on are sequentially scanned, and the heaters 6-1 to 6-9 are driven in a time-sharing manner.

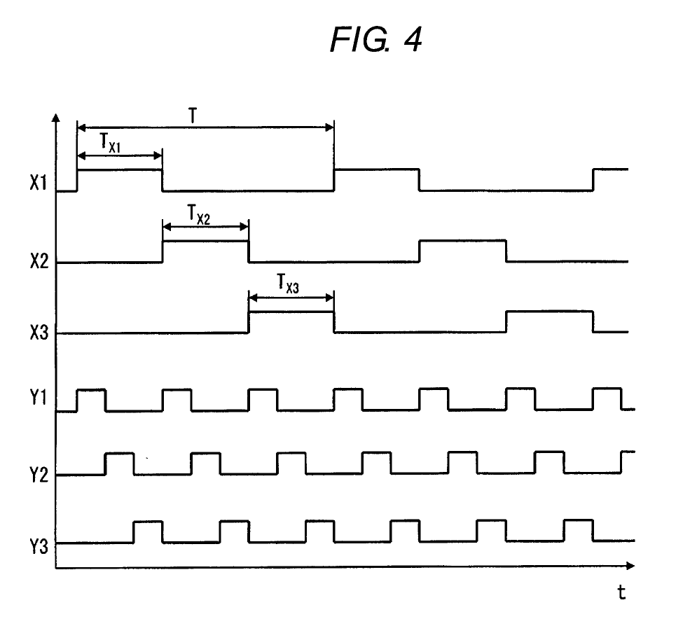

FIG. 4 is a view for explaining steady-state scan, and FIG. 4 illustrates a driving signal for turning on the switching elements 3-1 to 3-3 corresponding to the connecting terminals X1 to X3 of the first power lines L1-1 to L1-3 in the row direction and a driving signal for turning on the switching elements 3-4 to 3-6 corresponding to the connecting terminals Y1 to Y3 of the second power lines L2-1 to L2-3 in the column direction. In the state of FIG. 4, the total operation amount for the nine channels is within 100%, and the operation amounts for the channels are equal to one another.

As illustrated in FIG. 4, the switching elements 3-4 to 3-6 corresponding to the connecting terminal Y1 to Y3 are sequentially turned on in a duration Tx₁ during which the switching element 3-1 corresponding to the connecting terminal X1 is turned on, the switching elements 3-4 to 3-6 corresponding to the connecting terminal Y1 to Y3 are sequentially turned on in a duration Tx₂ during which the switching element 3-2 corresponding to the connecting terminal X2 is turned on, and the switching elements 3-4 to 3-6 corresponding to the connecting terminal Y1 to Y3 are sequentially turned on in a duration Tx₃ during which the switching element 3-3 corresponding to the connecting terminal X3 is turned on.

That is, in a constant control period T, the first to ninth heater heaters 6-1 to 6-9 of FIG. 2 are sequentially driven in the time-sharing manner, and the time each of the heaters 6-1 to 6-9 is turned on is controlled such that each of the first to ninth heater heaters 6-1 to 6-9 becomes a duty according to the operation amount from the temperature regulator 2. In the first embodiment, for example, the control period T is set to about 10 seconds.

The control in the transient duration T2 during which the detection temperature (PV) at the hot plate 1 partially comes close to the setting temperature will be described below.

In the transient duration T2, a group including plural heaters is driven, the number of heaters constituting the group is decreased according to the total operation amount that is of the sum of the operation amounts for the nine channels, and the heaters are driven such that the heater having the channel whose temperature becomes the lowest, that is, the heater having the channel whose operation amount becomes the largest is mainly driven.

Specifically, when the total operation amount becomes 600% or less, the six heaters are driven in group, the six heaters are scanned, and the heater having the channel whose temperature becomes the lowest, that is, the heater having the channel whose operation amount becomes the largest is mainly scanned. When the total operation amount becomes 400% or less, the four heaters are driven in group, the four heaters are scanned, and the heater having the channel whose operation amount becomes the largest is mainly scanned. When the total operation amount becomes 200% or less, the two heaters are driven in group, the two heaters are scanned, and the heater having the channel whose operation amount becomes the largest is mainly scanned. The state in which the total operation amount becomes 100% or less is the steady state, and the nine heaters are sequentially driven in the time-sharing manner in the steady state.

Thus, in the transient duration, the six heaters, the four heaters, or the two heaters are driven and scanned in group according to the total operation amount such that the heater whose channel becomes the lowest temperature and the largest operation amount is mainly scanned.

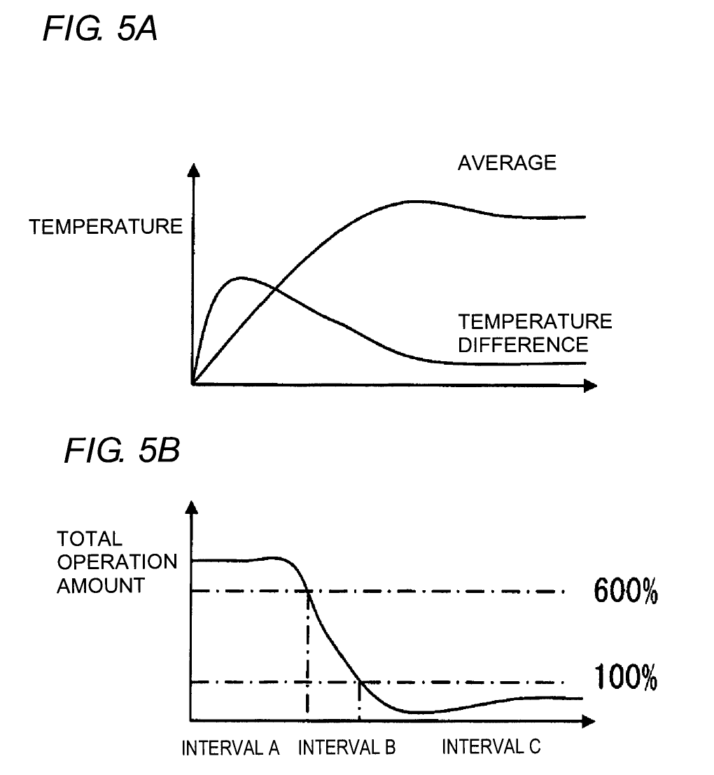

FIG. 5A illustrates an average temperature at the hot plate 1 and a maximum temperature difference between channels, and FIG. 5B illustrates a total operation amount of nine channels.

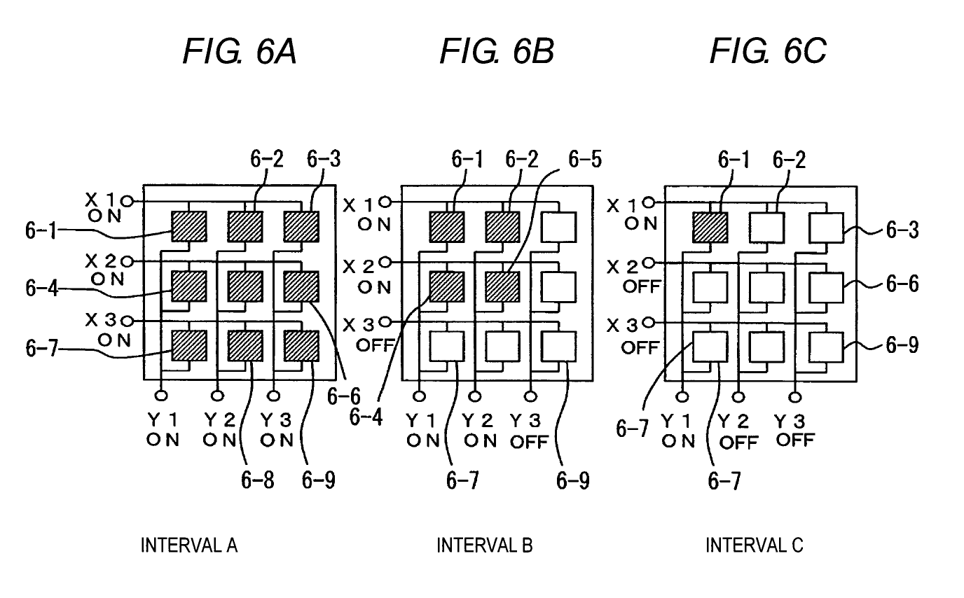

In an interval A in which the total operation amount ranges from 900% to 600%, as illustrated in FIG. 6A, all the heaters 6-1 to 6-9 are driven, and the duties of the heaters 6-1 to 6-9 are controlled according to the operation amounts. In FIG. 6, the driven heater is illustrated with diagonal lines.

In an interval B in which the total operation amount ranges from 600% to 100%, as described above, the six heaters, the four heaters, or the two heaters are driven and scanned in group according to the total operation amount such that the heater whose channel becomes the lowest temperature and the largest operation amount is mainly scanned. In the interval in which the total operation amount ranges from 400% to 200%, the four heaters are driven in group, for example, the four heaters 6-1, 6-2, 6-4, and 6-5 are driven as illustrated in FIG. 6B.

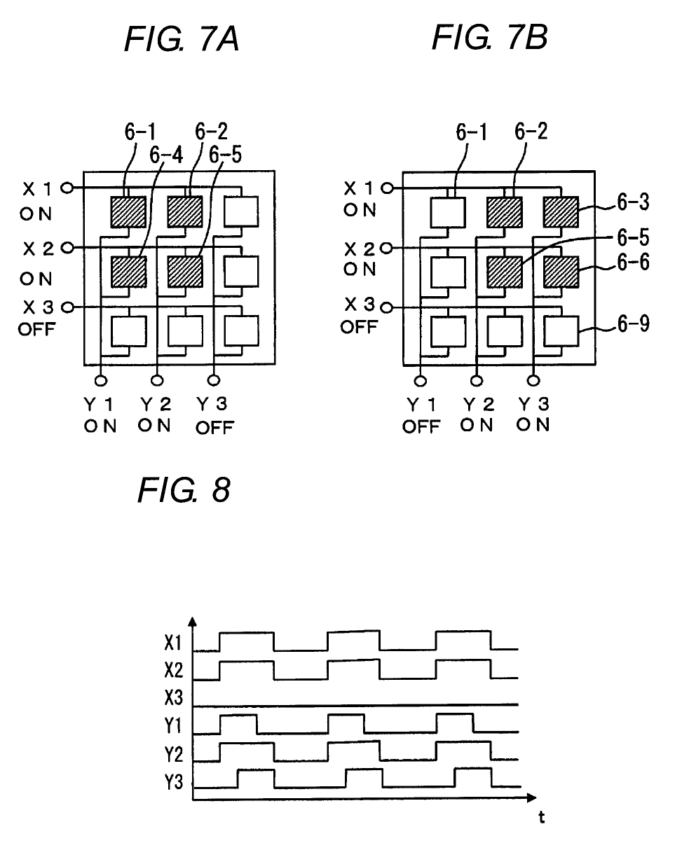

For example, when the four heaters are driven in group, the scan is performed as follows: the switching elements 3-1, 3-2, 3-4, and 3-5 corresponding to the connecting terminals X1 and X2 and Y1 and Y2 are turned on to the heaters 6-1, 6-2, 6-4, and 6-5 as illustrated in FIG. 7A, the switching elements 3-1, 3-2, 3-5, and 3-6 corresponding to the connecting terminals X1 and X2 and Y2 and Y3 are selected to drive the heaters 6-2, 6-3, 6-4, and 6-5 as illustrated in FIG. 7B, and scan is performed such that the heater whose channel becomes the lowest temperature and the largest operation amount, for example, the heater 6-2 is included. FIG. 8 illustrates the driving signal when the scan of FIG. 7 is performed.

The duty is controlled according to the operation amount when the six heaters, the four heaters, or the two heaters are driven in group.

In an interval C in which the total operation amount becomes 100% or less, the nine heaters are sequentially driven as illustrated in FIG. 6C.

In the output device 5, the turn-on and turn-off of the switching elements 3-1 to 3-6 are controlled to selectively drive the heaters 6-1 to 6-9 based on the operation amount for the nine channels from the temperature regulator 2.

In the first embodiment, the driving timing of the heaters 6-1 to 6-9 is described only by way of example. The driving timing can arbitrarily be selected according to required accuracy.

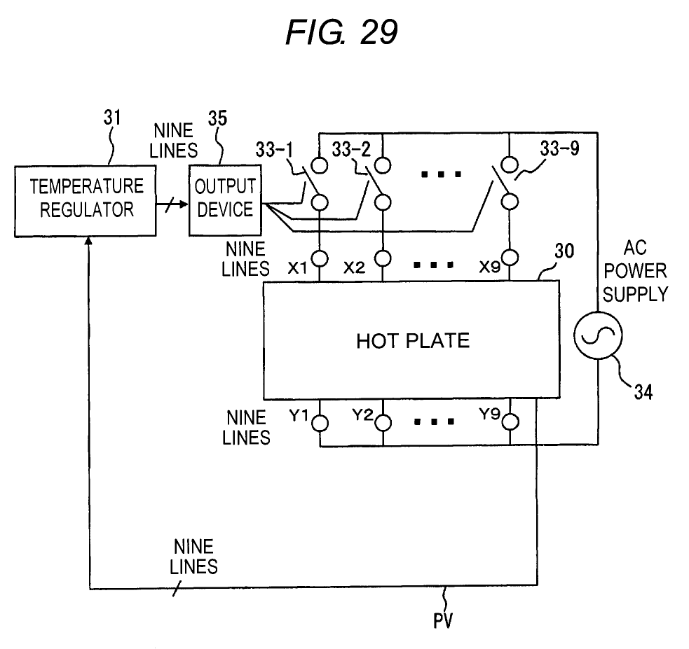

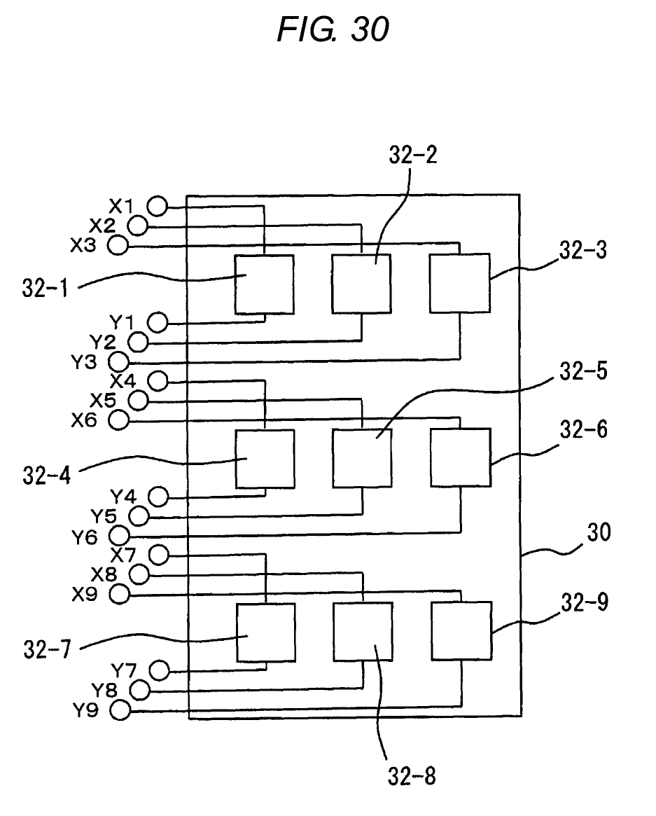

The heaters 6-1 to 6-9 are connected into the matrix form between the first power lines L1-1 to L1-3 and the second power lines L2-1 to L2-3, and the heaters 6-1 to 6-9 are selected and driven. Therefore, compared with the conventional techniques of FIGS. 29 and 30, the number of switching elements can be decreased from 9 elements to 6 elements while the number of power lines can be decreased from 18 lines to 6 lines. Consequently, the space design and wiring work for routing the power line having the large diameter are facilitated between the hot plate 1 and the output device 5.

As described above, when one of the nine heaters is selected and driven, the run-round of the leakage current is generated in not only the selected heater but also the surrounding heaters.

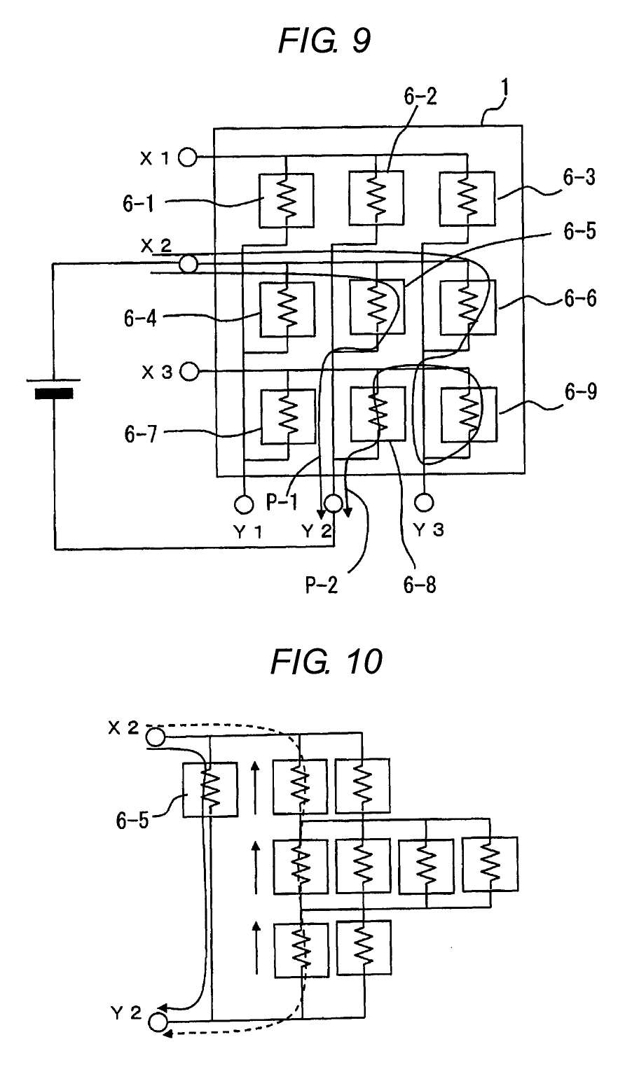

FIG. 9 is a view for explaining the current run-round. FIG. 9 illustrates an example in which the switching elements 3-2 and 3-5 corresponding to the connecting terminals X2 and Y2 are turned on to select and drive the fifth heater 6-5 located in the center of the hot plate 1. For the purpose of convenience, the direct-current power supply is illustrated in FIG. 9. A current is passed through the fifth heater 6-5 as indicated by an arrow P1, and plural loops are also generated by the current run-round in the surrounding heaters, for example, the current run-round is generated in the sixth, ninth, and eighth heaters 6-6, 6-9, and 6-8 as indicated by an arrow P2.

As illustrated in FIG. 10, the current run-round becomes series connection of the resistive elements constituting the heaters, and a resistance value becomes double to triple a resistance value of the selected heater. Accordingly, a current value of the run-round becomes ⅓ to ½ of the current value passed through the selected heater, and a heat generation amount becomes 1/9 to ¼ of the heat generation amount of the selected heater.

The heat generation amount becomes 1/9 to ¼ may be neglected in consideration of the thermal interference between the heaters. As a result of the experiments of the present inventor (Ikuo Nanno (2007) “Study on uniform temperature control of thermal process”, doctoral thesis, Graduate School of Science and Technology, Kumamoto University), for example, the interference between the two heaters 60 mm away from each other on a 3-mm aluminum substrate becomes 86%, and 1/9(11%) to ¼(25%) are negligibly-small values.

### Second Embodiment

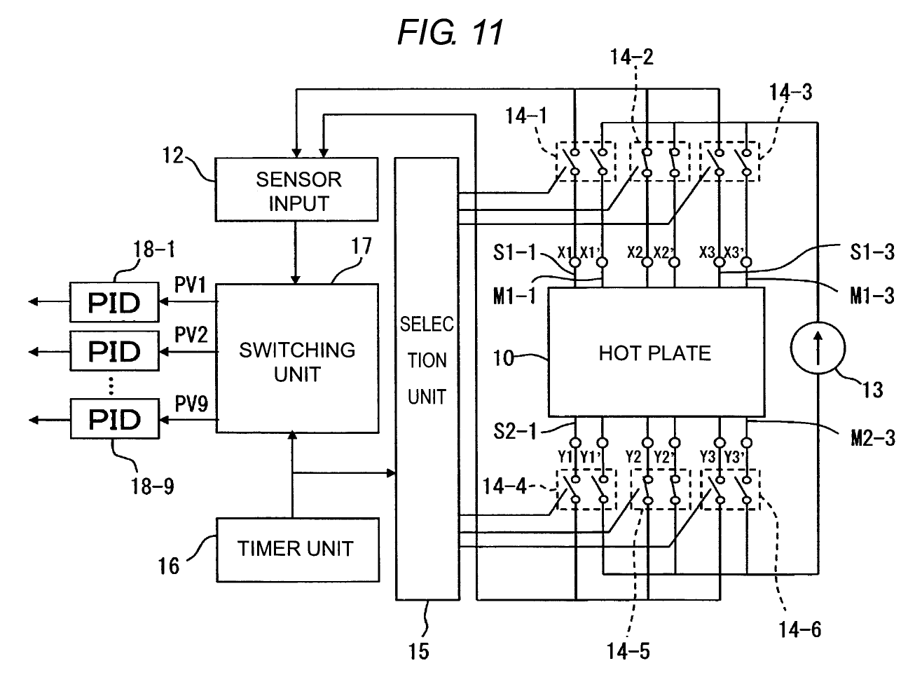

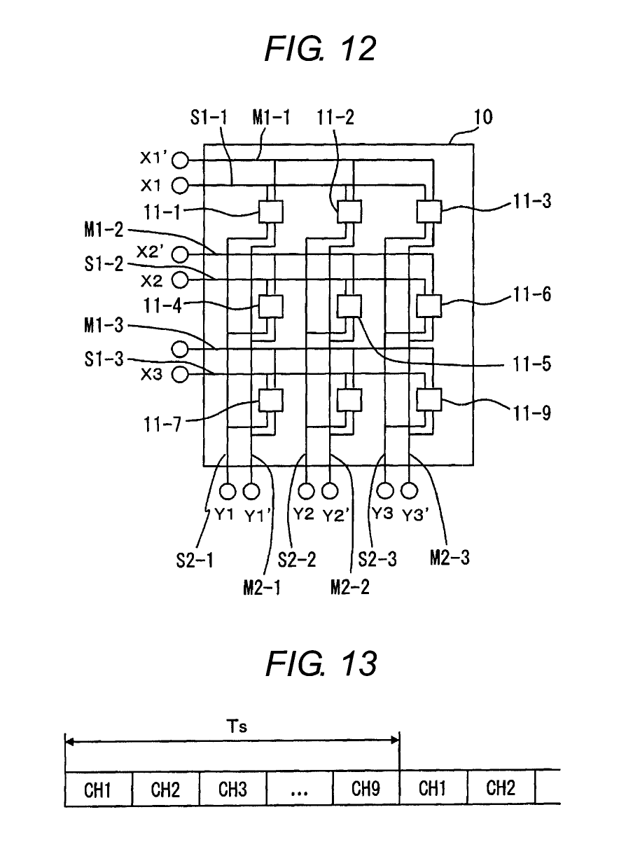

FIG. 11 illustrates a configuration of a temperature regulator that measures a temperature at a hot plate 10 to output an operation amount, and FIG. 12 illustrates a wiring structure of a resistance thermometer sensor that is of a temperature sensor provided in the hot plate 10 of FIG. 11.

In a second embodiment, as illustrated in FIG. 12, four-wire first to ninth resistance thermometer sensors 11-1 to 11-9 are provided as a temperature sensor that detects a temperature at the hot plate 10.

The first to ninth resistance thermometer sensors 11-1 to 11-9 are connected into the matrix form between signal lines S1-1 to S1-3 in the row direction and second signal lines S2-1 to S2-3 in the column direction in order to be connected to a sensor input circuit 12 of the temperature regulator.

One end of each of the first to third resistance thermometer sensors 11-1 to 11-3 is connected to the upper first signal line S1-1 in the row direction, and the other end is connected to each of the second signal lines S2-1 to S2-3 in the column direction. One end of each of the fourth to sixth resistance thermometer sensor 11-4 to 11-6 is connected to the intermediate first signal line S1-2 in the row direction, and the other end is connected to each of the second signal lines S2-1 to S2-3 in the column direction. One end of each of the seventh to ninth resistance thermometer sensors 11-7 to 11-9 is connected to the lower first signal line S1-3 in the row direction, and the other end is connected to each of the second signal lines S2-1 to S2-3 in the column direction.

The first to ninth resistance thermometer sensors 11-1 to 11-9 are connected into the matrix form between first wirings M1-1 to M1-3 in the row direction and second wirings M2-1 to M2-3 in the column direction in order to be connected to a constant current source 13 of the temperature regulator.

As illustrated in FIG. 11, the connecting terminals X1 to X3 of the row-directional first signal lines S1-1 to S1-3 led out from the hot plate 10 and connecting terminals X1′ to X3′ of the row-directional first wirings M1-1 to M1-3 led out from the hot plate 10 are connected to one end of the sensor input circuit 12 or the constant current source 13 through corresponding switching elements 14-1 to 14-3 that are of plural first opening and closing units of the temperature regulator. Each of the switching elements 14-1 to 14-3 includes a relay. The connecting terminals Y1 to Y3 of the column-directional second signal lines S2-1 to S2-3 led out from the hot plate 10 and connecting terminals Y1′ to Y3′ of the column-directional second wirings M2-1 to M2-3 led out from the hot plate 10 are connected to the other end of the sensor input circuit 12 or the constant current source 13 through corresponding switching elements 14-4 to 14-6 that are of plural second opening and closing units of the temperature regulator. Each of the switching elements 14-4 to 14-6 includes a relay.

Each of the switching elements 14-1 to 14-6 has two contacts, and each of the switching elements 14-1 to 14-6 is turned on and off in an interlocking manner. That is, the two contacts of the switching element 14-1 to which the first signal line S1-1 and the first wiring M1-1 are connected is turned on and off in the interlocking manner, the two contacts of the switching element 14-2 to which the first signal line S1-2 and the first wiring M1-2 are connected is turned on and off in the interlocking manner, and the two contacts of the switching element 14-3 to which the first signal line S1-3 and the first wiring M1-3 are connected is turned on and off in the interlocking manner.

Similarly, the two contacts of the switching element 14-4 to which the second signal line S2-1 and the second wiring M2-1 are connected is turned on and off in the interlocking manner, the two contacts of the switching element 14-5 to which the second signal line S2-2 and the second wiring M2-2 are connected is turned on and off in the interlocking manner, and the two contacts of the switching element 14-6 to which the second signal line S2-3 and the second wiring M2-3 are connected is turned on and off in the interlocking manner.

Accordingly, when one of the switching elements 14-1 to 14-3 and one of the switching elements 14-4 to 14-6 are turned on, a constant current is passed through the corresponding resistance thermometer sensor, and a voltage between both ends can be measured to measure the temperature.

A selection unit 15 of the temperature regulator performs the on-off control of the switching elements 14-1 to 14-6 in the time-sharing manner.

That is, the selection unit 15 performs the on-off control of the switching elements 14-1 to 14-6 based on an output of a timer unit 16, and a constant current is sequentially passed through the first resistance thermometer sensor 11-1 corresponding to a first channel CH1 to the ninth resistance thermometer sensor 11-9 corresponding to a ninth channel CH9 to take the voltage between both ends in the sensor input circuit 12 as illustrated in FIG. 13. The operation is repeated in a constant period Ts.

Based on the output from the timer unit 16, in synchronization with the selection of the selection unit 15, a switching unit 17 sequentially provides the inputs sequentially taken in the sensor input circuit 12 from the resistance thermometer sensors 11-1 to 11-9 as detection temperatures PV1 to PV9 of the channels CH1 to CH9 to PID control units 18-1 to 18-9 of corresponding channel.

That is, the switching unit 17 provides the input from the sensor input circuit 12 to the PID control unit 18-1 corresponding to the first channel CH1 when the selection unit 15 selects the first resistance thermometer sensor 11-1 corresponding to the first channel CH1, and the switching unit 17 provides the input from the sensor input circuit 12 to the PID control unit 18-2 corresponding to the second channel CH2 when the selection unit 15 selects the second resistance thermometer sensor 11-2 corresponding to the second channel CH2. Then the switching unit 17 provides the input to the PID control unit of each channel.

For example, the selection unit 15, the switching unit 17, and the PID control units 18-1 to 18-9 are formed by a microcomputer.

Conventionally, in the four-wire resistance thermometer sensor, two signal lines are required to be connected to the sensor input circuit, and two signal lines are required to be connected to the constant current source, that is, four signal lines are required in total. When the nine resistance thermometer sensors are used, 18 signal lines are required in total to be connected to the sensor input circuit, and 18 signal lines are required in total to be connected to the constant current source. On the other hand, in the second embodiment, the first to ninth resistance thermometer sensors 11-1 to 11-9 are connected in the matrix form between the first signal lines S1-1 to S1-3 in the row direction and the second signal lines S2-1 to S2-3 in the column direction and between the first wirings M1-1 to M1-3 in the row direction and the second wirings M2-1 to M2-3 in the column direction, and each of the resistance thermometer sensors is selected to measure the temperature. Therefore, the total number of signal lines connected to the sensor input circuit 12 can be decreased to 6 lines, and the total number of wirings connected to the constant current source 13 can be decreased to 6 lines.

The temperature measurement of the second embodiment may be applied to the temperature measurement of the first embodiment of FIG. 1.

As with the heater, the current run-round is generated for the sensor formed by the resistance thermometer sensor.

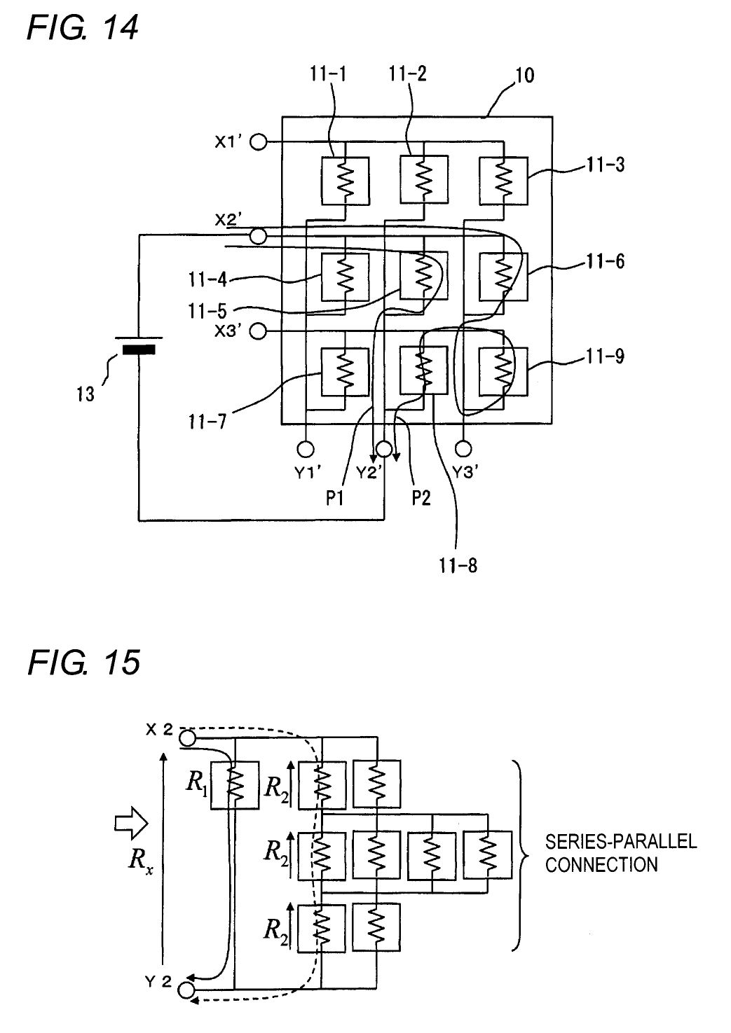

For example, as illustrated in FIG. 14, the switching elements 14-2 and 14-5 corresponding to the connecting terminals X2′ and Y2′ are turned on, and the fifth resistance thermometer sensor 11-5 located in the center of the hot plate 10 is selected to pass the current from the constant current source 13. Therefore, the current is passed through the fifth resistance thermometer sensor 11-5 as indicated by the arrow P1, and plural loops are also generated by the current run-round in the surrounding resistance thermometer sensors, for example, the current run-round is generated in the sixth, ninth, and eighth resistance thermometer sensors 11-6, 11-9, and 11-8 as indicated by the arrow P2.

As illustrated in FIG. 15, the current run-round becomes series-parallel connection of the resistance thermometer sensors. Assuming that a resistance value R₁ of the selected resistance thermometer sensor is equal to a resistance value R₂ of other resistance thermometer sensors, the whole of resistance value Rx is decreased by about 44%. Therefore, the temperature can be measured same as before by setting the current value higher by 44%.

The reason the resistance value is decreased by about 44% by the formation of the run-round loop will be described below.

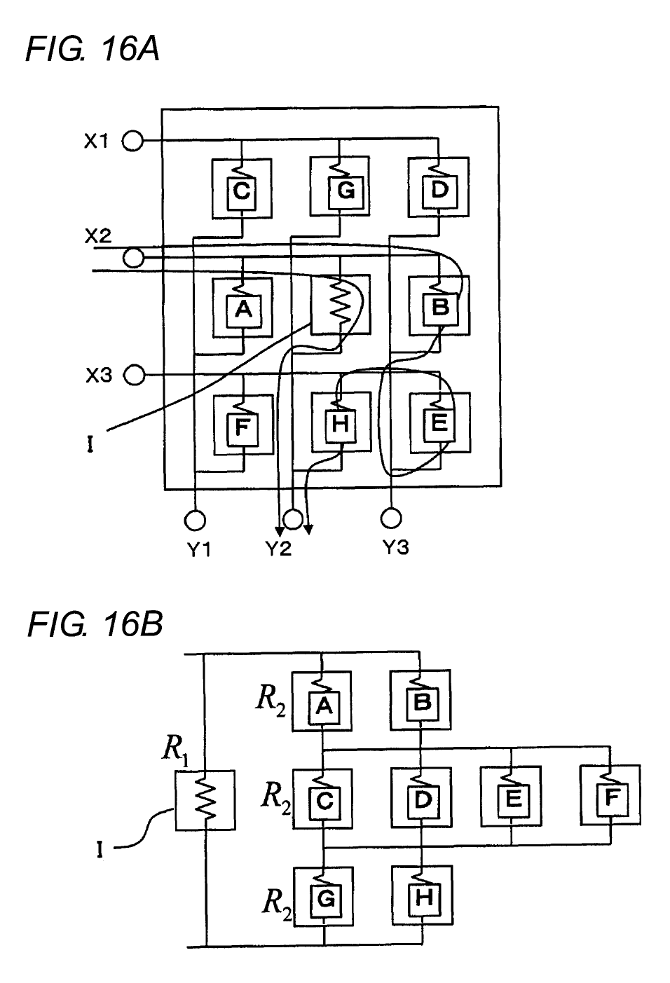

As illustrated in FIG. 16A, in the nine resistive elements A to I connected in the matrix form, it is assumed that the voltage is applied between the terminal X2 and the terminal Y2 to pass the current through the central resistive element I.

At this point, as illustrated in FIG. 16B, the connection among the resistive elements A to I is expressed by a three-layer state including the parallel connection of the horizontal resistive elements A and B, the parallel connection of the resistive elements C, D, E, and F located at four corners, and the parallel connection of the vertical resistive elements G and H. Assuming that the resistive elements A to H have the same resistance value, the voltage is not changed even if the three layers are connected. Therefore, the three layers are connected.

Assuming that the parallel connection of the horizontal resistive elements A and B (resistance value is R₂/2), the parallel connection of the resistive elements C, D, E, and F located at four corners (resistance value is R₂/4), and the parallel connection of the vertical resistive elements G and H (resistance value is R₂/2) are connected in series, a combined resistance Rx is computed as follows:

$$\begin{matrix}Rx = \{ {R}_{1} \cdot ( 5 / 4 ) \cdot {R}_{2} \} / \{ {R}_{1} + ( 5 / 4 ) \cdot {R}_{2} \} \\ = R 1 - \{ 4 {R}_{1}^{2} / ( 4 {R}_{1} + 5 {R}_{2} ) \} \\ = R 1 \{ 1 - ( 4 / 9 ) \}\end{matrix}$$

The resistance value is decreased by about 44%.

Accordingly, as described above, the temperature can be measured same as before by setting the current value higher by 44%.

In the first and second embodiments, the heater formed by the resistive element and the sensor are used. The reason the resistive element is preferably used will be described.

The heating and the measurement cannot locally be performed in a matrix structure of a thermoelectric transducer having a principle of the thermoelectric conversion except for the resistive element.

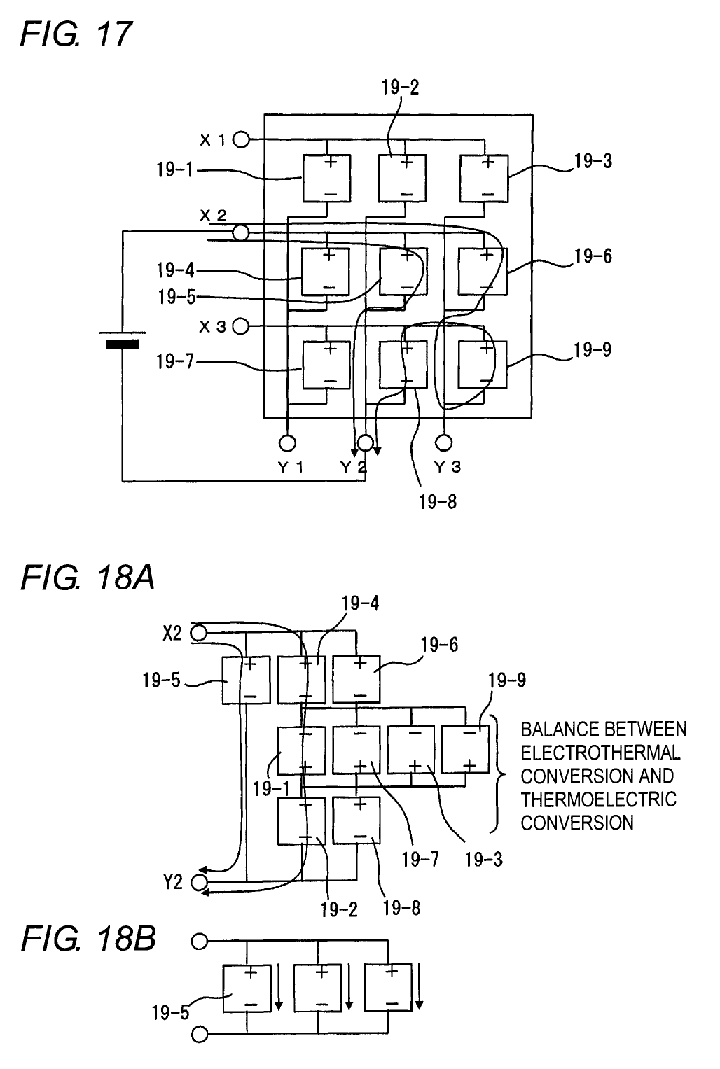

For example, the case in which a Peltier element is used instead of the resistance heater will be described with reference to FIG. 17. First to ninth Peltier elements 19-1 to 19-9 are connected into the matrix form to the hot plate 1. When the connecting terminals X2 and Y2 are connected to the power supply to drive the central fifth Peltier element 19-5, the first to ninth Peltier elements 19-1 to 19-9 are equal to one another in the thermoelectromotive force due to the run-round as illustrated in FIG. 18A, so that the first to ninth Peltier elements 19-1 to 19-9 can be regarded as a three-layer series-parallel connection.

In the three-layer series-parallel connection, the voltage generated by the parallel connection of the four Peltier elements and the voltage generated by the parallel connection of the two Peltier elements negate each other. That is, one of the parallel connection of the four Peltier elements and the parallel connection of the two Peltier elements generates the temperature difference (heat) from the electromotive force (electricity), the other generated the electromotive force (electricity) from the temperature difference (heat), and both negate each other. Consequently, as illustrated in FIG. 18B, the case in which the connecting terminals X2 and Y2 are connected to the power supply to drive the central fifth Peltier element 19-5 is substantially equal to the case in which the two Peltier elements are connected in parallel to the central fifth Peltier element 19-5. Although the heat is intended to be generated by one Peltier element, the heat is generated in the whole of the first to ninth Peltier elements 19-1 to 19-9 including the surrounding Peltier elements, and the control becomes difficult.

The three-layer series-parallel connection will be described.

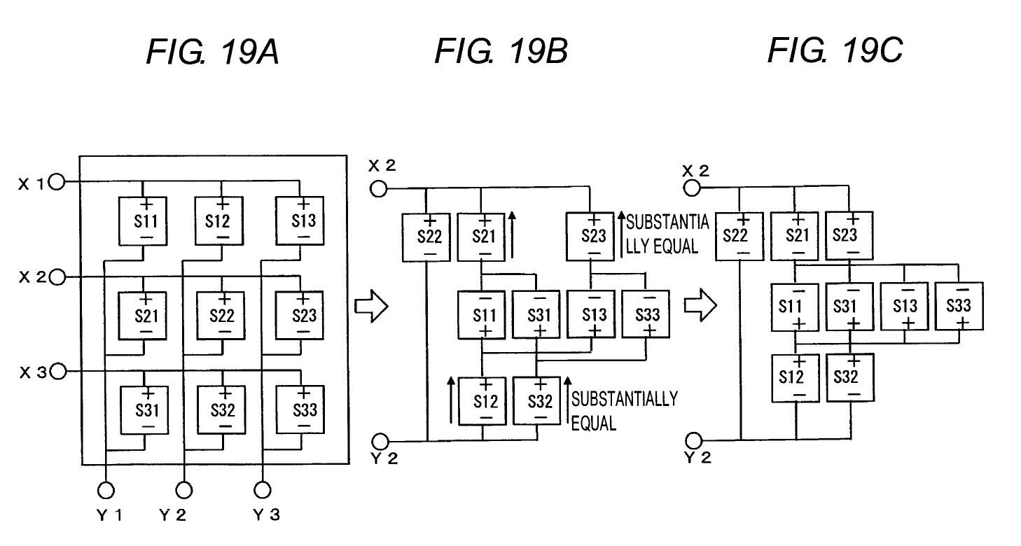

When the difference in temperature at the whole of the hot plate is relatively smaller than room temperature, for example, when the voltages at the thermoelectric transducers S21 and S23 are substantially equal to each other while the voltages at the thermoelectric transducers S12 and S32 are substantially equal to each other as illustrated in FIG. 19A, it may be considered that the nine thermoelectric transducers S11 to S33 are connected as illustrated in FIG. 19B. As a result, the circuit loop caused by the run-round is equivalent to the connection illustrated in FIG. 19C, that is, the circuit loop can be replaced by the three-layer series-parallel connection.

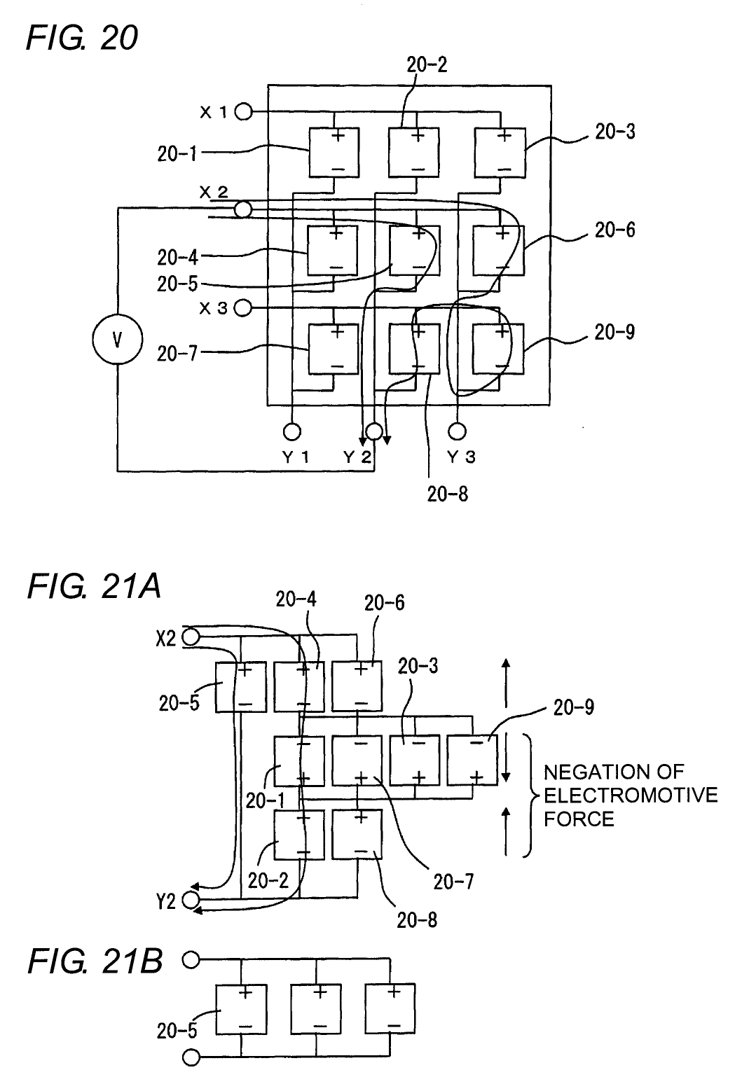

The case in which a thermocouple is used instead of the resistance thermometer sensor will be described with reference to FIG. 20. First to ninth thermocouples 20-1 to 20-9 that are of the temperature sensors are connected into the matrix form to the hot plate 10. When the central fifth thermocouple 20-5 is selected and measured, because the circuit loops are substantially equal to one another in the thermoelectromotive force between the connecting terminals X2 and Y2 due to the run-round, it can be considered to be the three-layer series-parallel connection as illustrated in FIG. 21A. Because the voltage generated by the parallel connection of the four thermocouples and the voltage generated by the parallel connection of the two thermocouples negate each other, the series-parallel connection of FIG. 21A becomes the parallel connection of the three thermocouples as illustrated in FIG. 21B, whereby an average temperature is detected.

Accordingly, even if any combination of the terminals is measured, the substantially same measured value is obtained, and the local temperature cannot be measured.

The thermoelectric transducer, such as the Peltier element and the thermocouple, in which the electricity and the temperature difference are bi-directionally converted is hardly used in the matrix connection.

### Third Embodiment

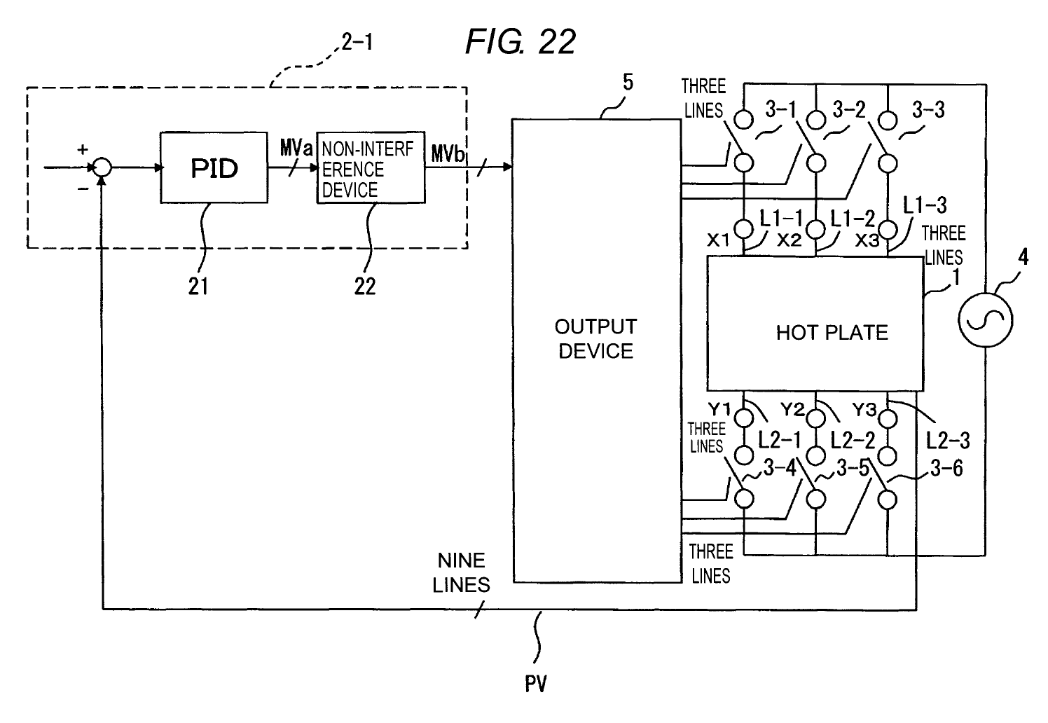

FIG. 22 illustrates a schematic configuration of a temperature control system according to a third embodiment of the present invention, and the configuration of FIG. 22 corresponds to the configuration of FIG. 1.

As described above, when one of the heaters 6-1 to 6-9 is selected and driven, the run-round of the leakage current is generated in not only the selected heater but also the surrounding heaters to generate the heat.

The heat generated from the surrounding heaters except for the selected heater due to the leakage current is treated as interference, and non-interference is achieved so as to negate the heat generated by the leakage current.

In the third embodiment, a temperature regulator 2-1 includes a PID control unit 21 and a non-interference device 22. The PID control unit 21 operates the operation amount for the nine channels based on a deviation between a setting temperature and the detection temperature (PV) from nine temperature sensors (not illustrated) provided in the hot plate 1. The non-interference device 22 converts an operation amount MVa for the nine channels from a PID control unit 21 so as to negate the interference of the leakage current. A non-interference operation amount MVb is provided to the output device 5.

In the third embodiment, other configurations are similar to those of the first embodiment.

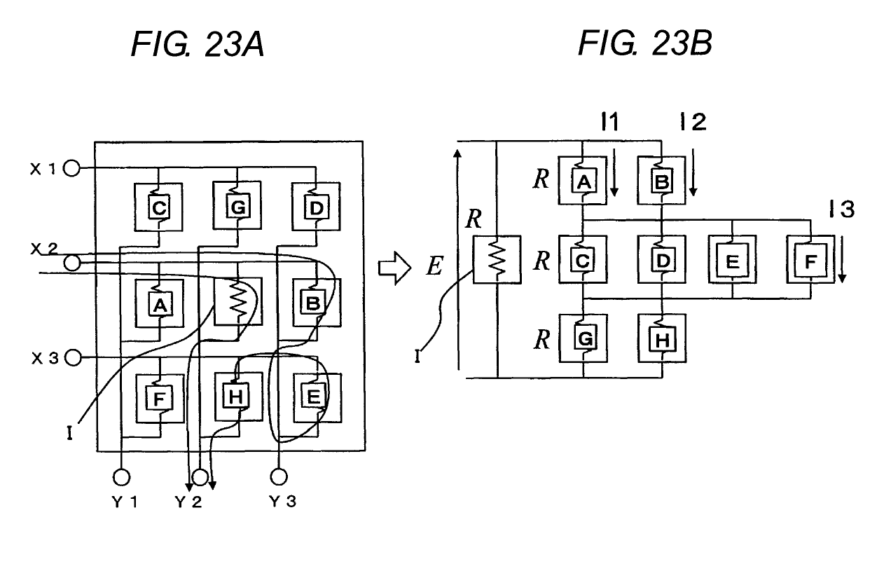

In order to design the non-interference device 22, it is necessary to previously estimate a degree of the heat generated by the leakage current. FIG. 23A illustrates the case in which the voltage is applied between the connecting terminals X2 and Y2 to drive the central heater I while the nine heaters A to I are connected into the matrix form.

For the purpose of simple calculation, as illustrated in FIG. 23B, the connection among the heaters A to I is expressed in the three-layer state including the parallel connection of the horizontal heaters A and B, the parallel connection of the heaters C, D, E, and F at four corners, and the parallel connection of the vertical heaters G and H. Assuming that the heaters A to I have the same resistance value, the voltage is not changed even if the three layers are connected. Therefore, the three layers are connected.

Assuming that the parallel connection of the horizontal heaters A and B, the parallel connection of the heaters C, D, E, and F at four corners, and the parallel connection of the vertical heaters G and H are connected in series, a heat generation amount P of the selected heater I is computed as follows:

P=E²/R

Heat generation amounts P_{A}, P_{B}, P_{G}, and P_{H} of the parallel connection of the horizontal heaters A and B and the parallel connection of the vertical heaters G and H are computed as follows:

P_{A}=P_{B}=P_{G}=P_{H}=4E²/25R

heat generation amounts P_{c}, P_{D}, P_{E}, and P_{F} of the parallel connection of the heaters C, D, E, and F are computed as follows:

Pc=P_{D}=P_{E}=P_{F}=E²/25R

The interference between the channels by the leakage current is computed for all the channels to obtain the following interference matrix (1) expressing the degree of interference:

$$\begin{matrix}[ Formula 1 ] & \\ [ \begin{matrix}1 & 4 / 25 & 4 / 25 & 4 / 25 & 1 / 25 & 1 / 25 & 4 / 25 & 1 / 25 & 1 / 25 \\ 4 / 25 & 1 & 4 / 25 & 1 / 25 & 4 / 25 & 1 / 25 & 1 / 25 & 4 / 25 & 1 / 25 \\ 4 / 25 & 4 / 25 & 1 & 1 / 25 & 1 / 25 & 4 / 25 & 1 / 25 & 1 / 25 & 4 / 25 \\ 4 / 25 & 1 / 25 & 1 / 25 & 1 & 4 / 25 & 4 / 25 & 4 / 25 & 1 / 25 & 1 / 25 \\ 1 / 25 & 4 / 25 & 1 / 25 & 4 / 25 & 1 & 4 / 25 & 1 / 25 & 4 / 25 & 1 / 25 \\ 1 / 25 & 1 / 25 & 4 / 25 & 4 / 25 & 4 / 25 & 1 & 1 / 25 & 1 / 25 & 4 / 25 \\ 4 / 25 & 1 / 25 & 1 / 25 & 4 / 25 & 1 / 25 & 1 / 25 & 1 & 4 / 25 & 4 / 25 \\ 1 / 25 & 4 / 25 & 1 / 25 & 1 / 25 & 4 / 25 & 1 / 25 & 4 / 25 & 1 & 4 / 25 \\ 1 / 25 & 1 / 25 & 4 / 25 & 1 / 25 & 1 / 25 & 4 / 25 & 4 / 25 & 4 / 25 & 1\end{matrix} ] & ( 1 )\end{matrix}$$

A non-interference matrix (2) for negating the interference is obtained as an inverse matrix of the interference matrix (1):

$$\begin{matrix}[ Formula 2 ] & \\ [ \begin{matrix}1.09 & - 0.1 & - 0.1 & - 0.1 & 0.01 & 0.01 & - 0.1 & 0.01 & 0.01 \\ - 0.1 & 1.09 & - 0.1 & 0.01 & - 0.1 & 0.01 & 0.01 & - 0.1 & 0.01 \\ - 0.1 & - 0.1 & 1.09 & 0.01 & 0.01 & - 0.1 & 0.01 & 0.01 & - 0.1 \\ - 0.1 & 0.01 & 0.01 & 1.09 & - 0.1 & - 0.1 & - 0.1 & 0.01 & 0.01 \\ 0.01 & - 0.1 & 0.01 & - 0.1 & 1.09 & - 0.1 & 0.01 & - 0.1 & 0.01 \\ 0.01 & 0.01 & - 0.1 & - 0.1 & - 0.1 & 1.09 & 0.01 & 0.01 & - 0.1 \\ - 0.1 & 0.01 & 0.01 & - 0.1 & 0.01 & 0.01 & 1.09 & - 0.1 & - 0.1 \\ 0.01 & - 0.1 & 0.01 & 0.01 & - 0.1 & 0.01 & - 0.1 & 1.09 & - 0.1 \\ 0.01 & 0.01 & - 0.1 & 0.01 & 0.01 & - 0.1 & - 0.1 & - 0.1 & 1.09\end{matrix} ] & ( 2 )\end{matrix}$$

The non-interference device 22 of the temperature regulator 2-1 converts the operation amount MVa (MVa₁ to MVa₉) from the PID control unit 21 into the non-interference operation amount MVb (MVb₁ to MVb₉) using the inverse matrix (2).

$$[ \begin{matrix}{MV}_{b 1} \\ {MV}_{b 2} \\ {MV}_{b 3} \\ {MV}_{b 4} \\ {MV}_{b 5} \\ {MV}_{b 6} \\ {MV}_{b 7} \\ {MV}_{b 8} \\ {MV}_{b 9}\end{matrix} ] = [ \begin{matrix}1.09 & - 0.1 & - 0.1 & - 0.1 & 0.01 & 0.01 & - 0.1 & 0.01 & 0.01 \\ - 0.1 & 1.09 & - 0.1 & 0.01 & - 0.1 & 0.01 & 0.01 & - 0.1 & 0.01 \\ - 0.1 & - 0.1 & 1.09 & 0.01 & 0.01 & - 0.1 & 0.01 & 0.01 & - 0.1 \\ - 0.1 & 0.01 & 0.01 & 1.09 & - 0.1 & - 0.1 & - 0.1 & 0.01 & 0.01 \\ 0.01 & - 0.1 & 0.01 & - 0.1 & 1.09 & - 0.1 & 0.01 & - 0.1 & 0.01 \\ 0.01 & 0.01 & - 0.1 & - 0.1 & - 0.1 & 1.09 & 0.01 & 0.01 & - 0.1 \\ - 0.1 & 0.01 & 0.01 & - 0.1 & 0.01 & 0.01 & 1.09 & - 0.1 & - 0.1 \\ 0.01 & - 0.1 & 0.01 & 0.01 & - 0.1 & 0.01 & - 0.1 & 1.09 & - 0.1 \\ 0.01 & 0.01 & - 0.1 & 0.01 & 0.01 & - 0.1 & - 0.1 & - 0.1 & 1.09\end{matrix} ] \times [ \begin{matrix}{MV}_{a 1} \\ {MV}_{a 2} \\ {MV}_{a 3} \\ {MV}_{a 4} \\ {MV}_{a 5} \\ {MV}_{a 6} \\ {MV}_{a 7} \\ {MV}_{a 8} \\ {MV}_{a 9}\end{matrix} ]$$

The non-interference device may be provided not in the temperature regulator, but on the output device side.

### Other Embodiments

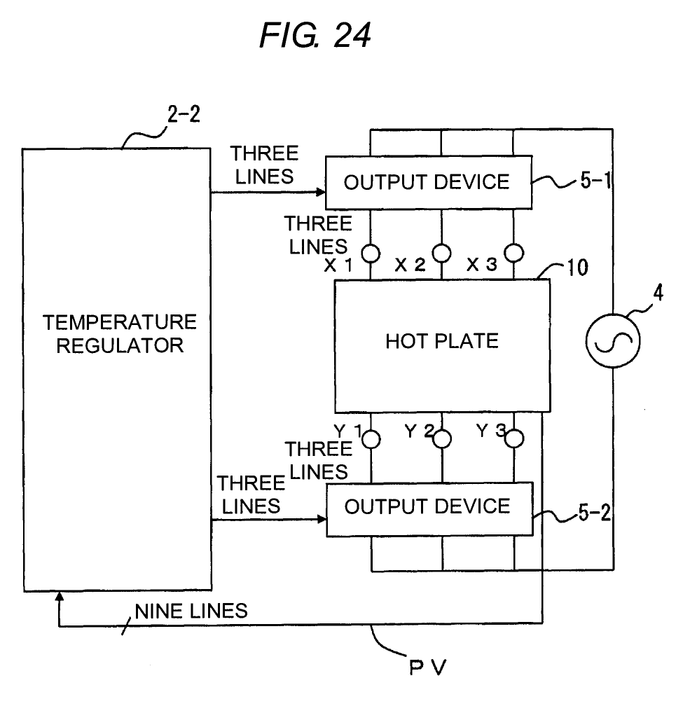

In the first embodiment, the selection unit that selects the heater to be driven is incorporated in the output device 5. Alternatively, in another embodiment of the present invention, as illustrated in FIG. 24, the selection unit is incorporated in a temperature regulator 2-2, and output devices 5-1 and 5-2 in which the switching elements are incorporated may be controlled by a driving signal provided from the temperature regulator 2-2.

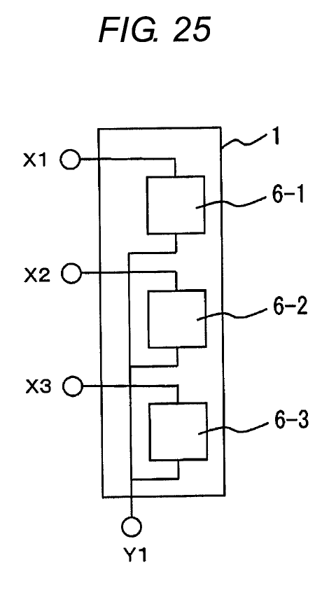

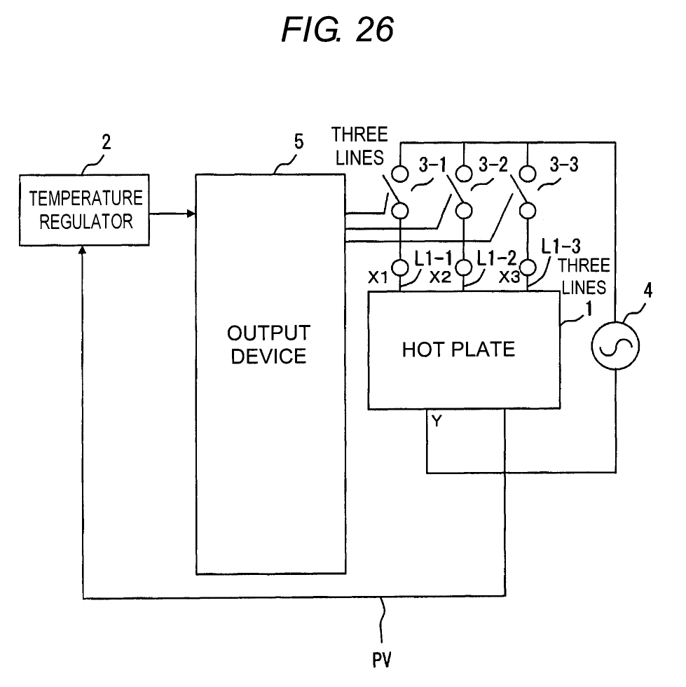

In the first to third embodiments, the heaters of the hot plate are connected into the matrix form. Alternatively, in another embodiment of the present invention, plural heaters may be connected in one row or one column. For example, three heaters 6-1 to 6-3 are connected on a line as illustrated in FIG. 25, and a connecting terminal Y commonly connected to one end of each of the heaters 6-1 to 6-3 may be connected to one end of the power supply 4 while connecting terminals X1, X2, and X3 of a common power line at the other end of each of the heaters 6-1 to 6-3 are connected to the other end of the power supply 4 through switching elements 3-1 to 3-3 as illustrated in FIG. 26.

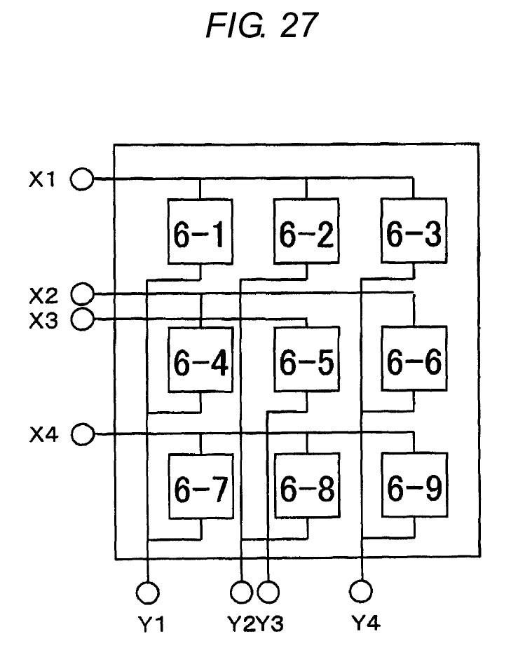

In the first embodiment, all the heaters 6-1 to 6-9 are connected into the matrix form. Alternatively, in another embodiment of the present invention, as illustrated in FIG. 27, at least one of the heaters, for example, the central heater 6-5 in which the heat is hardly dissipated while excessive heating is easily generated is not connected in to the matrix form, but the heater 6-5 may separately be driven to enhance control performance.

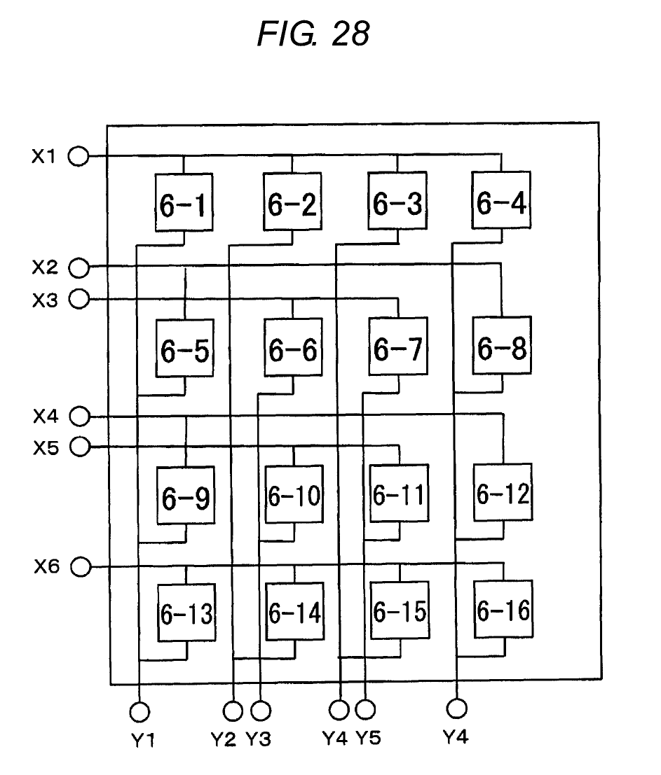

As illustrated in FIG. 28, for example, in the case of 16 heaters 6-1 to 6-16, a first power line in the row direction and a second power line in the column direction may separately be provided for the central heaters 6-6, 6-7, 6-10, and 6-11.

The present invention is useful to the multi-channel control.

What is claimed is:

1. A wiring structure that connects a plurality of heaters to a power supply, wherein
the plurality of heaters are connected in a matrix form between a plurality of first power lines and a plurality of second power lines,
the plurality of first power lines are connected to the power supply through a plurality of corresponding row first opening and closing units,
the plurality of second power lines are connected to the power supply through a plurality of corresponding column second opening and closing units, and
each of the heaters to be connected to the power supply is selected by opening and closing the corresponding first opening and closing unit and the corresponding second opening and closing unit.

2. The wiring structure according to claim 1, wherein each of the heaters is formed of a resistive element.

3. A wiring structure that connects a plurality of sensors to a sensor input circuit, wherein
the plurality of sensors are connected in a matrix form between a plurality of first signal lines and a plurality of second signal lines,
the plurality of first signal lines are connected to the sensor input circuit through a plurality of corresponding row first opening and closing units,
the plurality of second signal lines are connected to the sensor input circuit through a plurality of corresponding column second opening and closing units, and
each of the sensors to be connected to the sensor input circuit is selected by opening and closing the corresponding first opening and closing unit and the corresponding second opening and closing unit.

4. The wiring structure according to claim 3, wherein each of the sensors is formed of a resistive element.

5. A heater driving device comprising:
the wiring structure according to claim 1; and
a selection unit that selects the heater to be connected to the power supply by controlling the opening and closing of the first opening and closing units and the second opening and closing units.

6. A measurement device comprising:
the wiring structure according to claim 3; and
a selection unit that selects the sensor to be connected to the sensor input circuit by controlling the opening and closing of the first opening and closing units and the second opening and closing units.

7. A control system comprising the heater driving device according to claim 5.

8. A control system comprising the measurement device according to claim 6.

9. A control system that controls a temperature of a control target provided with a plurality of heaters, the plurality of heaters being connected in a matrix form between a plurality of first power lines and a plurality of second power lines, the plurality of first power lines being connected to the power supply through a plurality of corresponding row first opening and closing units, the plurality of second power lines being connected to the power supply through a plurality of corresponding column second opening and closing units,
the control system comprising:
a temperature control unit that outputs an operation amount based on a setting temperature and a detection temperature from a plurality of temperature sensors for detecting a temperature of the control target; and
a first selection unit that selects each of the heaters to be driven by controlling the opening and closing of the corresponding first opening and closing unit and the corresponding second opening and closing unit based on the operation amount from the temperature control unit.

10. The control system according to claim 9, wherein each of the heaters is formed of a resistive element.

11. The control system according to claim 9, further comprising a non-interference unit that converts the operation amount from the temperature control unit and provides the converted amount to the first selection unit so as to cancel heat generated by a current bypassing the heater selected by the selection unit.

12. The control system according to claim 9, wherein a plurality of temperature sensors are further provided in the control target,
the plurality of temperature sensors are connected in a matrix form between a plurality of first signal lines and a plurality of second signal lines,
the plurality of first signal lines are connected to a sensor input circuit through a plurality of corresponding row third opening and closing units,
the plurality of second signal lines are connected to the sensor input circuit through a plurality of corresponding column fourth opening and closing units,
the control system further includes:
a second selection unit that selects the temperature sensors connected to the sensor input circuit by controlling the opening and closing of the corresponding third opening and closing unit and the corresponding fourth opening and closing unit; and
a switching unit that switches and provides an input outputted from each of the temperature sensors through the sensor input circuit to a plurality of temperature control units corresponding to the temperature sensors of the temperature control unit, and
the temperature control unit controls the second selection unit based on the input of each of the temperature sensors from the switching unit and corresponding each of setting temperatures.

13. The control system according to claim 12, wherein each of the temperature sensors is formed of a resistive element.
